(19) United States
(12) Patent Application Publication
(10) Pub. No.: US 2020/0190883 A1
(43) Pub. Date: Jun. 18, 2020

(54) ACTUATOR BASED SELF REGULATING COUNTERBALANCE MECHANISM WITH FRICTION

(71) Applicant: MAGNA CLOSURES INC., Newmarket (CA)

(72) Inventors: Joseph Scheuring, Richmond Hill (CA); Wieslaw Nowicki, Mississauga (CA)

(21) Appl. No.: 16/710,238

(22) Filed: Dec. 11, 2019

Related U.S. Application Data
(60) Provisional application No. 62/780,572, filed on Dec. 17, 2018.

(51) Int. Cl. E05F 3/16; B60J 5/10

(52) U.S. Cl. CPC E05F 3/16; E05F 15/622; E05Y 2900/546; B60J 5/101

(57) ABSTRACT

A friction mechanism coupled to a drive system for mounting in a housing of a counterbalance mechanism for a closure panel of a vehicle, including: a shaft having an axis; a friction member positioned on the axis; a pinion with a friction body positioned on the shaft and adjacent to the friction member, the pinion rotatable about the axis relative to the friction member during rotation of the shaft to generate friction between the friction member and the friction body; a pusher body positioned on the axis; an actuator of the drive system connected to the pusher body in order to affect an axial position of the pusher body on the axis; and a resilient element positioned on the axis between the pusher body and the friction member, such that the resilient element exerts an axial force on the friction member to force the friction member against the friction body; wherein operation of the actuator causes a change in the axial position of the pusher body on the axis and thus a degree of compression of the resilient element positioned between the pusher body and the friction member.

### CROSS-REFERENCE TO RELATED APPLICATION

This application claims priority from the benefit of the filing date of U.S. Provisional Patent Application No. 62/780,572 filed on Dec. 17, 2018, entitled “ACTUATOR BASED SELF REGULATING COUNTERBALANCE MECHANISM WITH FRICTION”, the contents of which are herein incorporated by reference.

### FIELD

This disclosure relates to a friction based counterbalance mechanism for a closure panel.

### BACKGROUND

Some vehicles are equipped with a closure panel, such as a lift gate, which is driven between an open position (position 2) and a closed position (position 1) using an electric drive system. Hold systems have been proposed to provide such vehicles with the capability of assisting the operator of the closure panel, in order to maintain a third position hold (or position 2) during opening and closing operations, so as to help counteract the weight of the closure panel itself. Without these hold systems, the closure panel may sag back down at the top end of the operational opening range due to the closure panel weight providing a closure torque greater than an opening torque provided by the electric drive system. Also recognized is a need to provide an extension (e.g. actuated or counterbalance) mechanism that can be used to provide appropriate friction to the open/close operation of the closure panel.

Further disadvantages of current hold systems include bulky form factors which take up valuable vehicle cargo space, requirement to have additional lift support systems in tandem such as gas struts and other counterbalance mechanisms, unacceptable impact on manual open and close efforts requiring larger operator applied manual force at the panel handle, undesirable force spikes that do not provide for smoother manual force/torque curves, requirement to use vehicle battery power to maintain third position hold, and/or temperature effects resulting in variable manual efforts required by the operator due to fluctuations in ambient temperature.

It is recognized that constantly applied forces in a counterbalance mechanism can be problematic due to variations in the geometry and/or operator positioning during the complete raise and lowering cycle of a closure panel, including the ability to provide for third position hold where desired.

Further, it is recognized that friction-based systems can undesirably vary in performance (e.g. variance in set/degree of applied friction) over time. Factors that can undesirably affect the amount of friction provided by a friction mechanism can include: component wear/degradation; ambient temperature fluctuation; as well as loss/fluctuation in vehicle battery/power.

### SUMMARY

It is an object of the present invention to provide an actuator assisted variable friction mechanism for application in a counterbalance mechanism that obviates or mitigates at least one of the above presented disadvantages.

One advantage of an actuator assisted variable friction mechanism is the actuator is activated (e.g. moved in position as powered/instructed by a control module) to engage or otherwise increase the amount of friction force generated during operation of the counterbalance mechanism. In particular, the actuator can be used to actively facilitate (e.g. control) a desired variability in the friction force generated during different stages/positions of the closure panel travel, as the closure panel travels between the open and closed positions.

A further advantage of an actuator assisted variable friction mechanism is the actuator can actively adjust (e.g. moved in position as control as powered/instructed by a control module) the friction force generated in order to actively compensate for mechanism wear/degradation (e.g. thinning of components due to material removal due to wear of the components during repeated cycling). In particular, the actuator can be used to actively compensate for undesired variability in the friction force generated due to component wear/degradation.

A further advantage of an actuator assisted variable friction mechanism is actuator can actively adjust (e.g. moved in position as control as powered/instructed by a control module) the amount of friction force generated based on a sensed grade (level vs. incline vs. decline) of the vehicle in order to vary (e.g. actively add or remove) a certain amount of friction to facilitate balancing of the closure panel depending on the grade angle of the vehicle. For example, the actuator can be used to vary the friction force generated (based on sensed grade angle) in order to inhibit the closure panel from swinging undesirably open/shut on a grade other than level.

A further advantage of an actuator assisted variable friction mechanism is the actuator can actively adjust (e.g. moved in position as control as powered/instructed by a control module) the generated friction force based on sensed temperature (e.g. ambient) in order to vary (e.g. add or remove) a certain amount of friction to facilitate the closure panel remains balanced, for example to inhibit the closure panel from swinging undesirably open/shut due to temperature fluctuations. For example, temperature could affect any of the spring/grease/friction pad of the friction mechanism and thus the amount of friction generated, e.g. colder temperatures could make the spring contract and decrease the friction force generated.

A further advantage of an actuator assisted variable friction mechanism is actuator can actively adjust (e.g. moved in position as control as powered/instructed by a control module) the generated friction force as a result of different operating modes of the closure panel. For example during a manual mode, there can be a first degree of friction force generated to provide the closure panel is balanced during operation between the closed and open positions. Whereas during a powered mode, the friction is changed by the actuator to a second degree of friction (e.g. less than the first degree of friction) in order to reduce efforts on the motor, recognizing that still some friction force generation can remain (e.g. be maintained due to the position of the actuator) in the event vehicle power to the motor of the actuator is lost/interrupted.

A further advantage of an actuator assisted variable friction mechanism is the actuator can actively adjust (e.g. moved in position as control as powered/instructed by a control module) the friction force generated based on a user preference setting, or an OEM setting, in order to provide the closure panel with a lighter or heavier feel to the user. For example, during a manual mode the closure panel can be given some resistance to the manual motion (as a result of a selected manual mode position of the actuator) based on the user moving closure panel, which will be felt by the user.

A further advantage of an actuator assisted variable friction mechanism is that once the actuator is positioned, if power is lost to the control of the actuator (e.g. to the motor connected to the actuator), the actuator can remain in position.

A first aspect provided is a variable friction mechanism coupled to a drive system for mounting in a housing of a counterbalance mechanism for a closure panel of a vehicle, including: a shaft having an axis; a friction member positioned on the axis; a pinion with a friction body positioned on the shaft and adjacent to the friction member, the pinion rotatable about the axis relative to the friction member during rotation of the shaft to generate friction between the friction member and the friction body; a pusher body positioned on the axis in relation to the friction member; and an actuator coupled to the pusher body for varying an axial position of the pusher body along the axis relative to the friction member; wherein operation of the actuator causes a change in the axial position of the pusher body on the axis and thus a change in a magnitude of the friction generated between the friction member and the friction body.

A second aspect provided is a friction based counterbalance mechanism for coupling with a closure panel of a vehicle to assist in opening and closing of the closure panel, the counterbalance mechanism including: a housing having a first pivot connection mount for connecting to one of a body of the vehicle and the closure panel; an extension member coupled to the housing and being extendable and retractable with respect to the housing, the extension member for connecting by a second pivot connection mount to the other of the body and the closure panel; a variable friction mechanism mounted in the housing having: a shaft having an axis; a friction member positioned on the axis; a pinion with a friction body positioned on the shaft and adjacent to the friction member, the pinion rotatable about the axis relative to the friction member during rotation of the shaft to generate friction between the friction member and the friction body; a drive system including: a pusher body positioned on the axis in relation to the friction member; and an actuator coupled to the pusher body for varying an axial position of the pusher body along the axis relative to the friction member; and a lead screw coupled to the extension member on one end and coupled to the shaft on the other end, such that extension and retraction of the extension member with respect to the housing causes rotation of the lead screw and the shaft about the axis; wherein varying the axial position of the pusher body on the axis changes a magnitude of the friction generated between the friction member and the friction body.

A third aspect provided is a method controlling movement of a closure panel of a vehicle between an open position and a closed position using a variable friction mechanism positioned in a counterbalance mechanism, the variable friction mechanism including a friction member positioned adjacent to a friction body of a pinion and a drive system for operating the variable friction mechanism, the method including the steps of: coupling rotary motion of a lead screw of the counterbalance mechanism with rotary motion of the pinion; adjusting a bias of the friction member against the friction body by operation of the drive system in a first direction to increase friction between the friction member and the friction body; and adjusting the bias of the friction member against the friction body by operation of the drive system in second direction opposite the first direction to decrease friction between the friction member and the friction body.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1 is a perspective view of a vehicle with a closure panel assembly;

FIG. 2 is an external view of an example biasing member;

FIG. 3 is a cross sectional view of the biasing member of FIG. 2 with an example counterbalance mechanism having a variable friction mechanism with a drive system in a housing of the biasing member;

FIG. 4 is an exploded view of the variable friction mechanism with drive system of FIG. 3;

FIGS. 5 and 6 show an enlarged section perspective views of the variable friction mechanism with drive system shown in FIG. 4;

FIG. 7 is a further enlarged section perspective view of the drive system and variable friction mechanism of FIG. 4;

FIG. 8 is a side section view of the variable friction mechanism with drive system shown in FIG. 4;

FIG. 9 shows an operational cross sectional view of the variable friction mechanism of FIG. 4 in a maximum friction state;

FIG. 10 shows an operational cross sectional view of the variable friction mechanism of FIG. 4 in a mid-level friction state;

FIG. 11 shows an operational cross sectional view of the variable friction mechanism of FIG. 4 in a minimum friction state;

FIGS. 12 and 13 show tables having various example friction values of the counterbalance mechanism of FIG. 4;

FIG. 14 illustrates an exemplary method of controlling movement of a closure panel of a vehicle between an open position and a closed position with the variable friction mechanism with drive system of FIG. 4.

FIG. 15 illustrates an exemplary method of controlling the friction force generated by the variable friction mechanism with drive system of FIG. 4, in accordance with another illustrative example;

FIG. 16 illustrates exemplary torque curves of a closure panel and a matching counter force curve generated by the variable friction mechanism of the example biasing member of FIG. 2;

FIG. 17 illustrates an exemplary method of controlling the friction force generated by the variable friction mechanism with drive system of FIG. 4, in accordance with another illustrative example;

FIG. 18 illustrates an exemplary method of controlling movement of a closure panel of a vehicle in tandem with a powered strut of FIG. 1 between an open position and a closed position with the variable friction mechanism with drive system of FIG. 4;

FIG. 19 is a system diagram of a control system for controlling movement of a closure panel, in accordance with an illustrative example; and

FIG. 20 illustrates an exemplary method of controlling movement of a closure panel of a vehicle between an open position and a closed position with the variable friction mechanism with drive system of FIG. 4, in accordance with another illustrative example.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

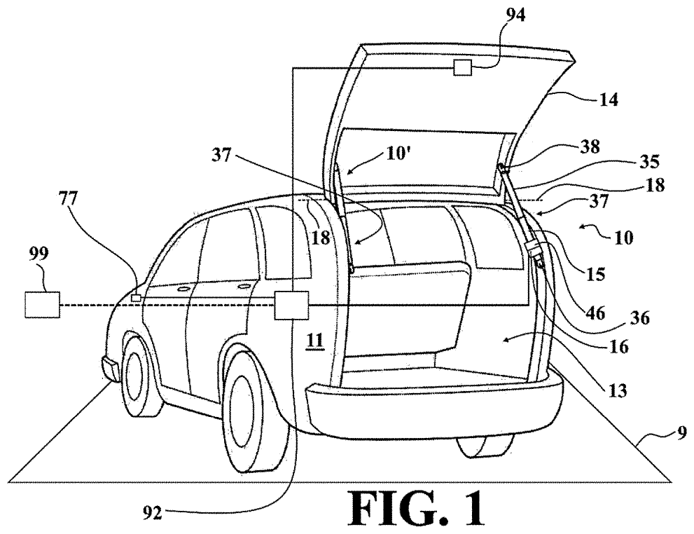

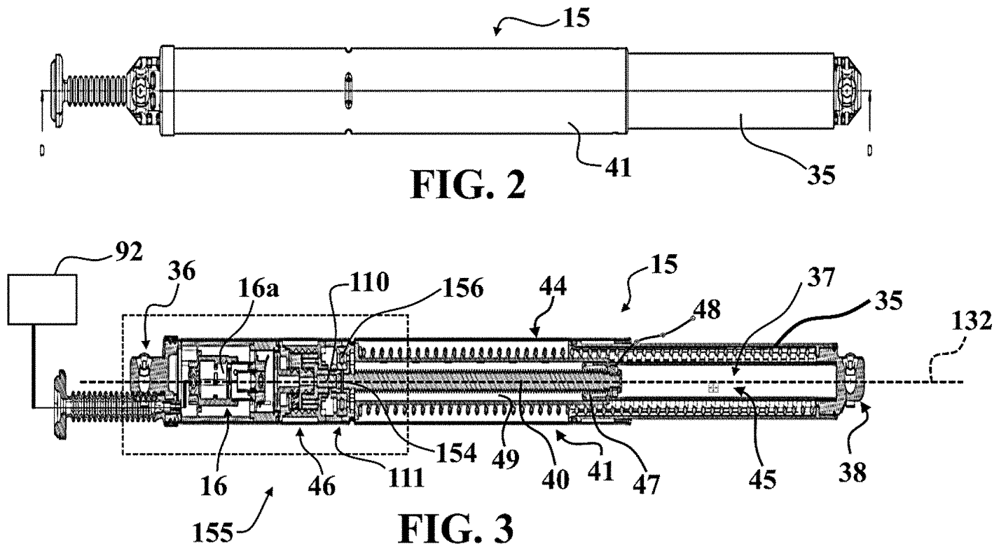

Provided is a counterbalance mechanism 15 (i.e. extension mechanism—see FIG. 1) that can be used advantageously with vehicle closure panels 14 to provide for open and close modes for operator assistance as discussed below, in particular for land-based, sea-based and/or air-based vehicles 10. Other applications of the counterbalance mechanism 15, in general for closure panels 14 both in and outside of vehicle applications, include advantageously assisting in optimization of overall hold and manual effort forces for closure panel 14 operation. It is recognized as well that the counterbalance mechanism 15 examples provided below can be used advantageously as the sole means of open and close assistance for closure panels 14 or can be used advantageously in combination (e.g. in tandem) with other closure panel 14 biasing members (e.g. spring loaded hinges, biasing struts, etc.). In particular, the counterbalance mechanism 15 can be friction assisted via one or more variable friction mechanisms 46 (see FIGS. 2 and 3) and used to provide or otherwise assist in a holding force (or torque) for the closure panel 14, as further described below. Further, it is recognized that the counterbalance mechanism can be integrated with a biasing member 37 (see FIGS. 1 and 3) such as a spring loaded strut and/or provided as a component of a closure panel assembly, as further described below. It is recognized that the biasing member 37, incorporating the counterbalance mechanism 15, can be implemented as a strut (see FIGS. 1, 2, 3 as example types of struts). The strut can be of a biasing type (e.g. spring and/or gas charge supplying the bias), can include a drive unit for example with a lead screw 40 (see FIG. 3) and/or as a counterbalance embodiment as shown. The strut can be of an electromechanical type (e.g. driven by the drive system 16, e.g. integrated motor assembly having an actuator 16a, with spring and/or gas charge supplying a bias, as desired.

Referring to FIG. 1, shown is the vehicle 10 with a vehicle body 11 having one or more closure panels 14. One example configuration of the closure panel 14 is a closure panel assembly including the counterbalance mechanism 15 (e.g. incorporated in the biasing member 37 embodied as a strut by example) and the drive system 16 (e.g. incorporating an electrically powered motor/drive also referred to as the actuator 16a). Drive system 16 may be for example an electric motor and lead screw type actuator configuration for moving a plunger 133 having a back driveable force characteristic greater than the force generated by the resilient element 128 which may be exerted on the actuator 16a by acting on the plunger 133 for example, in a manner as will be described herein below. Actuator 16a may alternatively be a solenoid actuator, but it is recognized other types of actuators may be provided for moving the plunger 133 and maintaining the plunger 133 at a position when the actuator 16a (e.g. servo motor) is commanded to not move the plunger 133 or a power disruption to the actuator 16a occurs. For vehicles 10, the closure panel 14 can be referred to as a partition or door, typically hinged, but sometimes attached by other mechanisms such as tracks, in front of an opening 13 which is used for entering and exiting the vehicle 10 interior by people and/or cargo. It is also recognized that the closure panel 14 can be used as an access panel for vehicle 10 systems such as engine compartments and also for traditional trunk compartments of automotive type vehicles 10. The closure panel 14 can be opened to provide access to the opening 13, or closed to secure or otherwise restrict access to the opening 13. It is also recognized that there can be one or more intermediate hold positions of the closure panel 14 between a fully open position and fully closed position, as provided at least in part by the counterbalance mechanism 15 as further described below. For example, the counterbalance mechanism 15 can assist in biasing movement of the closure panel 14 away from one or more intermediate hold position(s), also known as Third Position Hold(s) (TPHs) or Stop-N-Hold(s), once positioned therein. It is also recognized that the counterbalance mechanism 15 can be provided as a component of the closure panel assembly, such that the counterbalance mechanism 15 component can be separate from the one or more biasing members 37.

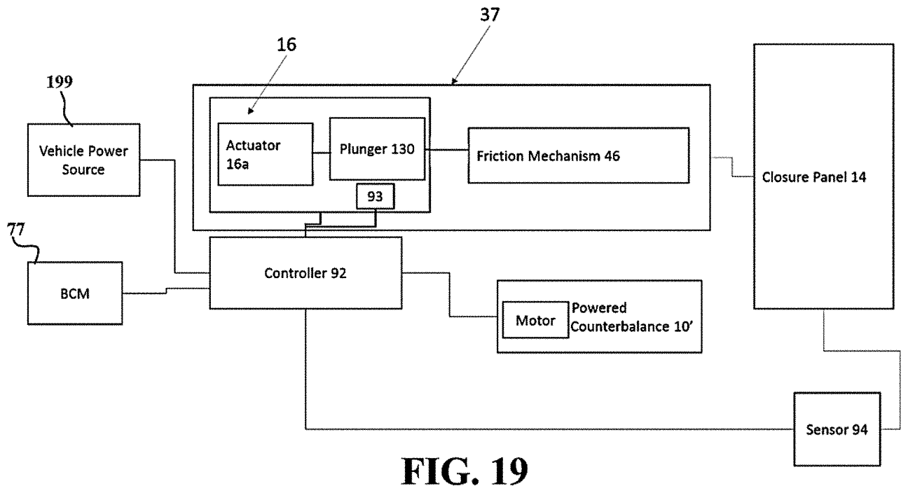

Still referring to FIG. 1, and additionally to FIG. 19, the motor-less biasing member 37 is shown in electrical communication with a controller or control system 92 in electrical communication with the drive system 16 to variably energize drive system 16, e.g. integrated motor assembly having an actuator 16a, such as by input of an ON/OFF command, or a variable command, such as a specific variable power/current level for speed control of the actuator 16a, in response to receiving a signal from a sensor 94 e.g. a linear sensor, hall sensor, accelerometer, or other type of sensor provided on motor-less biasing member 37 to detect as an example the motion of the extensible member 35, or as a accelerometer provided on the closure panel 14 to detect a motion or manual user control thereof, such as by moving the closure panel 14 in the open or closed directions, or by a user input via a wireless FOB, or by another sensor for determining the angular position of the closure panel 14. Accordingly, other sensor 94 types can be sensors such as but not limited to; an angle sensor, a temperature sensor, and a wear sensor (e.g. for sensing wear/degradation of components of the counterbalance mechanism 15 and/or the variable friction mechanism 46).

In response, the controller 92 will control the actuator 16a to increase or decrease the friction applied to the input 103 as described herein below. Control system 92 may also be in electrical communication with sensor 93 provided to detect a linear position of a plunger 133 of the drive system 16, to indirectly determine the compression amount of the spring 128 (e.g. resilient element) and therefore determine the friction force being generated by the variable friction mechanism 46. Control system 92 may also be configured to power an actuator or motor of a powered strut 10′, operating in conjunction with controlling the friction generation of the motor-less biasing member 37 in response for example to a detection of a motion of the closure panel 14 indicating a user's intent to initiate a powered movement or to stop the powered movement of the closure panel 14, or in response to a command signal from a vehicle control system, such as a Body Control Module 77, e.g. part of the control system 92, which can be configured to receive a command signal from a vehicle wireless key FOB 99, to power the power strut 10′ and/or control the friction output of motor-less biasing member 37 to move the closure panel 14 between an open and closed position. The motor-less counterbalance strut 37 is illustrated herein as not including a motor for rotating a lead screw 40 (see FIG. 3) as can be provided in powered strut 10′, thereby providing a reduced form factor of the motor-less biasing member 37 with a reduced longitudinal length and possibly circumference as compared to a powered strut such as powered strut 10′.

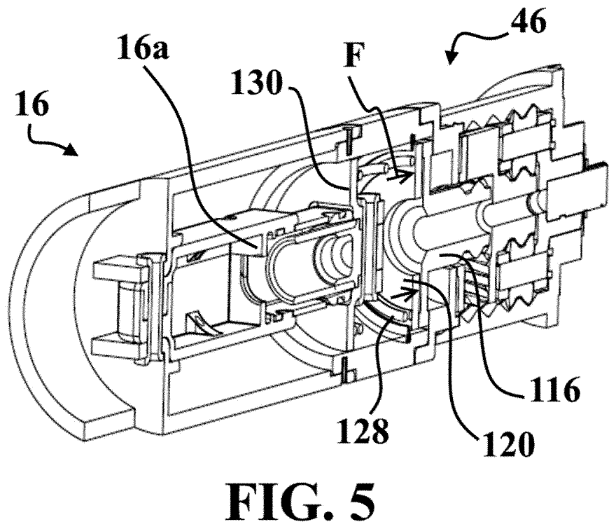

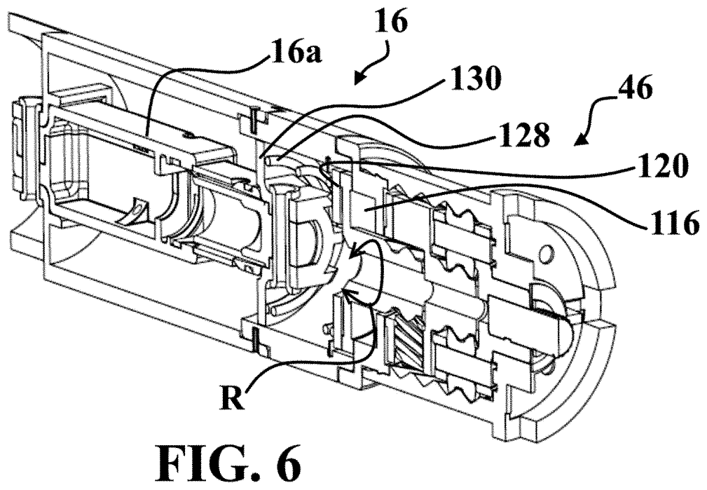

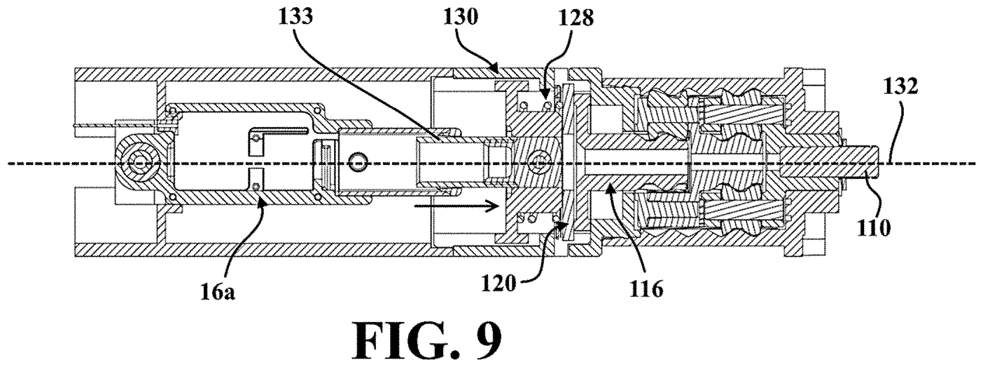

The counterbalance mechanism 15 can be powered electronically via the drive system 16, in order to adjust friction generated in a variable friction mechanism 46 (see FIGS. 5, 6). Additionally, one characteristic of the closure panel 14 is that due to the weight of materials used in manufacture of the closure panel 14, some form of force assisted open and close mechanism (or mechanisms) can be used to facilitate operation of the open and close operation by a user (e.g. vehicle driver) of the closure panel 14. The force assisted open and close mechanism(s) can be provided by the counterbalance mechanism 15, any biasing members 37 (e.g. spring loaded hinges, spring loaded struts, gas loaded struts, electromechanical struts, etc.) when used as part of the closure panel assembly, such that the counterbalance mechanism 15 is configured to provide a friction based holding torque (or force) (via the variable friction mechanism 46) that acts against the weight of the closure panel 14 on at least a portion of the panel open/close path about the third position hold, in order to help maintain the position of the closure panel 14 about the third position hold. The ability to provide friction by the counterbalance mechanism 15 is facilitated by the variable friction mechanism 46 in conjunction with the drive system 16 (see FIGS. 9, 10, 11 giving example states of the actuator 16a affecting the amount of friction generated by the variable friction mechanism 46).

It is recognized that a strut version of the counterbalance mechanism 15 can have the lead screw 40 operated either actively (i.e. driven) by a motor (not shown) or operated passively such that the lead screw 40 is free to rotate about its longitudinal axis 132 but is not actively driven by a motor. It is recognized that a travel member 47 (see FIG. 3) can be coupled to the lead screw 40, such that the travel member 47 is connected to an extension member 35 (e.g. solid rod, tube, etc.) connected to the closure panel 14. It can be the travel member 47 that is driven by extension and retraction of the extension member 35 with respect to a housing 41 of the counterbalance mechanism 15. As further discussed below, displacement of the travel member 47 along the longitudinal axis 132 can be used to drive rotation of the lead screw 40, for example.

It is recognized that the counterbalance mechanism 15 can be configured as an independent counterbalance mechanism for the closure panel 14 and/or can be configured as a component of the biasing member 37 (e.g. incorporated as an internal component of a strut).

In terms of vehicle 10, the closure panel 14 can be a lift gate as shown in FIG. 1, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 13 in the body 11 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 11 of the vehicle at the front, side or back of the door, as the application permits.

Referring again to FIG. 1, in the context of a vehicle application of a closure panel by example only, the closure panel 14 is movable between a closed position (not shown) and an open position (shown). In the embodiment shown, the closure panel 14 pivots between the open position and the closed position about a pivot axis 18, which is preferably configured as horizontal or otherwise parallel to a support surface 9 of the vehicle 10. In other embodiments, the pivot axis 18 can have some other orientation such as vertical or otherwise extending at an angle outwards from the support surface 9 of the vehicle 10. In still other embodiments, the closure panel 14 can move in a manner other than pivoting, for example, the closure panel 14 may translate along a predefined track or may undergo a combination of translation and rotation between the open and closed position.

Referring again to FIG. 1, as discussed above, the counterbalance mechanism 15 examples provided below (for the closure panel assembly) can be used as the sole means of open and close assistance for the inhibition of sag by the closure panels 14 themselves, or can be used in combination (e.g. in tandem or otherwise integrated) with one or more other closure panel biasing members 37 (e.g. spring loaded hinges, struts such as gas struts or spring loaded struts, etc.) that provide a primary connection of the closure panel 14 to the vehicle body 11 at pivot mount connections 36, 38 (see FIG. 1). In general operation of the closure panel 14, the drive system 16 is coupled to a proximal end of the counterbalance mechanism 15, including the variable friction mechanism 46, which in turn is coupled to the extension member 35 at a distal end (used to connect the closure panel 14 as a secondary connection other than the hinge at the pivot axis 18 to the vehicle body 11). As such, the extension member 35 and the counterbalance mechanism 15 (with the drive system 16 and variable friction mechanism 46) can be pivotally attached to the closure panel 14 at spaced apart locations as shown (for example as components of the biasing member 37).

In this manner, the other end of the extension member 35 pivotally connects to the closure panel 14 at pivot connection 36. It is recognized that the extension member 35 itself can be configured as a non-biasing element (e.g. a solid rod) or can be configured as a biasing element (e.g. a gas or spring assisted extension strut), as desired the extension member 35 can also be referred to as a nut tube 35, as desired.

Referring again to FIG. 1, one or more optional closure panel biasing members 37 (e.g. not containing the counterbalance mechanism 15) can be provided which urge the closure panel 14 towards the open position throughout at least some portion of the path between the open position and the closed position and which assist in holding the closure panel 14 in the open position. The closure panel biasing members 37 can be, for example, gas extension struts that are pivotally connected at their proximal end to the closure panel 14 and at their distal end to the vehicle body 11. In the embodiment shown, there are two biasing members 37 (one on the left side of the vehicle 10 and one on the right side of the vehicle 10). In one example, see FIG. 1, the counterbalance mechanism 15 can be coupled to the closure panel 14 on one side of the closure panel 14 as mounted internally to the biasing element 37, and the at another side of the closure panel 14 can be a differently configured biasing element 37 (e.g. not including the counterbalance mechanism with the drive system 16).

As the closure panel 14 moves between the open and closed positions, the torques (or forces) exerted on the closure panel 14 by the biasing members 37 and by the weight of the closure panel 14 itself can vary. In one embodiment, the closure panel 14 can have some position between the open and closed positions at which the torque (or force) exerted on the closure panel 14 by the biasing members 37 cancels out the torque (or force) exerted on the closure panel 14 by the weight of the closure panel 14 (i.e. the torque or force of the biasing member(s) 37 acts against the weight of the closure panel 14). Above this point (which can be referred to as a balance point or otherwise referred to as the intermediate hold position), the torque (or force) exerted by the biasing members 37 can overcome the torque (or force) exerted by the weight of the panel 14 thus resulting in a net torque (or force) away from the closed position, thus biasing the closure panel 14 towards the open position (i.e. the torque or force of the biasing member(s) 37 acts against the weight of the closure panel 14). Below this point, the torque (or force) exerted by the weight of the panel 14 can overcome the torque (or force) exerted by the biasing members 37 thus resulting in a net torque (or force) towards the closed position, thus biasing the closure panel 14 towards the closed position. However, even in travel of the closure panel 14 towards the closed position, the torque or force of the biasing member(s) 37 acts against the weight of the closure panel 14. In this manner, the effect of the biasing member(s) 37 is to provide a torque or force that always acts against the weight of the closure panel 14 (i.e. always supplies a closing torque or force). It is recognized that “3rd position hold” can also be referred to as an “intermediate hold position” or a “stop and hold position”. Accordingly, it is recognized that the variable friction mechanism 46 can be operated by the control system 92 in order to facilitate the proper positioning/operation of the closure panel 14 between the open and closed positions, based on the positioning of the actuator 16a as instructed by the control system 92. It is also recognized, as discussed, that the control system 92 can take into account one or more sensor 93,94 measurements with the generated instruction(s)/signal(s) to the actuator 16a, in order to actively adjust the degree/magnitude of the friction force generated by the variable friction mechanism 46 at any/all position(s) of the closure panel 14 (between the open and closed positions).

Further to operation of the above-described closure panel biasing members 37, one or more counterbalance mechanisms 15 are provided in addition to (as shown in FIG. 1) or in substitution of the biasing members 37. For example, one or more counterbalance mechanisms 15 can be provided which act to maintain or otherwise inhibit the closure panel 14 from travelling towards the closed position, i.e. assist in holding the closure panel 14 in the open position (e.g. intermediate hold positions and/or the fully open position). The one or more counterbalance mechanisms 15 can be, for example, coupled to or otherwise mounted on the vehicle body 11 and pivotally connected to the closure panel 14. In all cases, the counterbalance mechanism 15 contains the variable friction mechanism 46, as further described below, as assisted by the drive system 16.

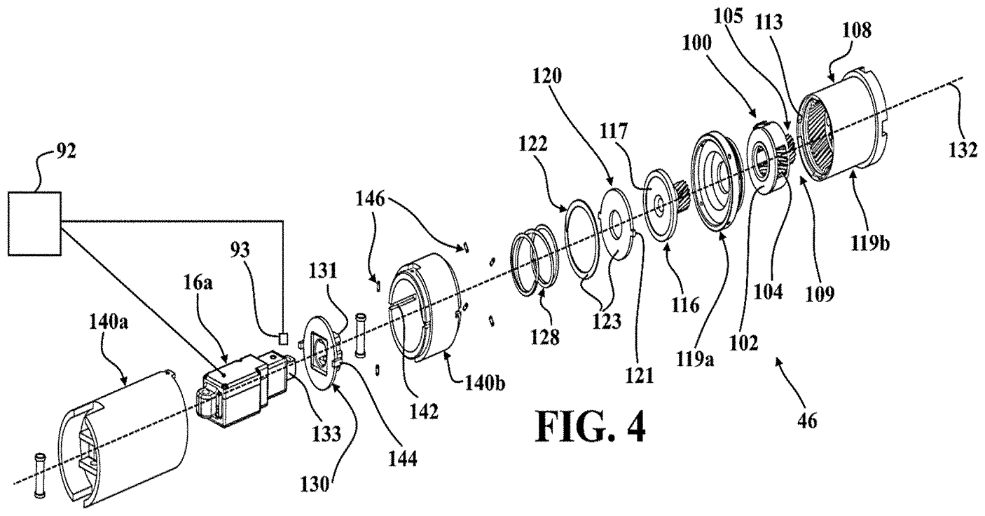

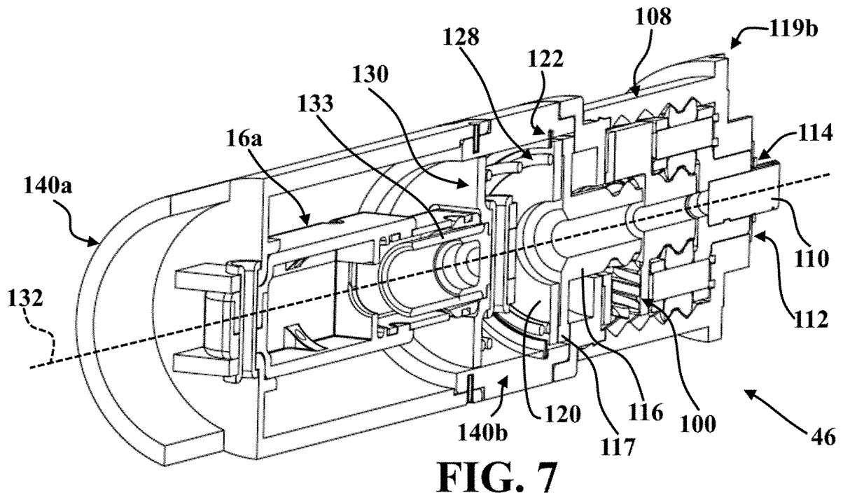

Referring to FIG. 4, shown is the variable friction mechanism 46 having a carrier assembly 100 containing a carrier 102 with gears 104 (e.g. planetary gears) mounted thereon via pins. The carrier assembly 100 is mounted within a ring gear 108 (e.g. part of planetary gears). A shaft 110 with washer 112 and clip 114 (see FIG. 7) is used to couple the carrier assembly 100 to one end of the ring gear 108, such that the shaft 110 is coupled to end 109 of the carrier 102. The ring gear 108 can have anti-rotation slots 113 to inhibit rotation of the ring gear 108 as the gears 104 rotate. A pinion 116 containing gear 118 (e.g. engaged with planetary gear set incorporating the gears 104) and friction body 117 is positioned on the axis 132, such that the gear 118 engages gears 104 of the carrier assembly 100. Gears 104 form part of a speed reducing and torque multiplying geartrain assembly 101 having the input 103, such as gear 118, and an output 105, such as end 109, such that a retarding rotational force generated by friction applied to the input 103 will be multiplied and outputted at the output 105 to control the rotation of the lead screw 40 in a manner as will be described herein. A washer 120 (also referred to as a rotor) is positioned to one side of the friction body 117. Anti-rotation tabs 121 can be positioned on the washer 120 in order to inhibit rotation of the washer 120 with respect to the housing 140b, 119a as pinion 116 rotates. A clip 122 is also mounted on the axis 132, thus defining the position of the pinion 116 with respect to the carrier assembly 100 along the axis 132. The housing 140b can be connected to the housing 119b by an adaptor 119a, as desired. A spring 128 (e.g. resilient element) is positioned between a pusher body 130 and the washer 120 (e.g. friction member), such that the spring 128 is in a compressed/expanded state depending upon an axial position of the pusher body 130 along axis 132 with respect to the washer 120, as sensed for example by a linear sensor 93 provided to detect a linear position of the plunger 133 of the drive system 16 which is configured to extend and retract to move the pusher body 130. Sensor 93 may be configured to detect the position of the pusher body 130 as another example. As such, it is recognized that a degree of compression/expansion of the spring 128 depends upon the space (being variable) between a shoulder 131 of the pusher body 130 and the opposing face 123 of the washer 120. The resilient element 128 is used to bias the washer 120 against the friction body 117 in order to generate friction there between. It is recognized that increasing or decreasing the bias of the resilient element 128 (e.g. via operation of the actuator 16a affecting the position of the pusher body 130 along the axis 132) causes a corresponding increase or decrease in a magnitude of the friction being generated between the washer 120 and the friction body 117.

The variable friction mechanism 46 also can have a cover 140a with a housing 140b having anti-rotation slots 142 for mating with anti-rotation ribs 144 of the pusher body 130, in order to inhibit rotation of the pusher body 130 during rotation of the pinion 116. The cover 140a couples to housing 140b, which in turn couples to the ring gear 108, for example via pins 146. As further described below, operation of the actuator 16a causes translation of the pusher body 130 along the axis 132 (either towards or away from the washer 120).

Referring to FIG. 3, shown is the variable friction mechanism 46 connected to the counterbalance mechanism 15. The shaft 110 is coupled to the lead screw 40 (for conjoint rotation) via coupler 111 secured by pin 154. The coupler 111 and pin 154 can be collectively referred to as an adaptor 155 used to couple the lead screw 40 to the shaft 110 for conjoint rotation. As such, the rotation of the shaft 110 also causes conjoint rotation of the carrier 102 of the carrier assembly 100. As such, rotation of the carrier 102 also causes rotation of the pinion 116 via engagement of the gears 104 with the gear 118. As the pinion 116 rotates about the axis 132, the friction body 117 generates friction with the washer 120 biased into engagement with the friction body 117 via the resilient element 128. As further described below, the magnitude or strength of the bias of the resilient element 128 depends upon the position of the pusher body 130 along the axis 132, as dictated (e.g. as adjusted) by the actuator 16a. A bearing 156 can be used to position the lead screw 40 and the shaft 110 along the axis 132 with respect to the ring gear 108.

The counterbalance mechanism 15 can have a spring 42 (e.g. resilient element) mounted on a spring support tube 43 and covered by a spring cover tube 44 of the housing 41. The pivot mount connection 38 (e.g. ball socket 38) is connected (e.g. welded) to the extension member 35 (e.g. nut tube 35) at one end and a travel member 47 is connected (e.g. crimped via bushing 48) to the extension member 35 at the other end. As such, as the travel member 47 travels along the lead screw 40 (along the axis 132), the extension member 35 extends/retracts with respect to a cavity 49 of the spring support tube 43. As such, the nut tube 35 is one example of the extension member 35 of FIG. 1. As such, the nut tube 35 is can be interchanged with the extension member 35 for exemplary purposes only. The travel member 47 (e.g. FIG. 3) can be fixed (e.g. non-rotating about the axis 132 along the lead screw 40). It is recognized that the travel member 47 may not rotate around the lead screw 40, rather the travel member 47 can travel linearly along the longitudinal axis 132 and linearly along a body of the lead screw 40 as the lead screw 40 rotates (is rotated) about the longitudinal axis 132, such that the travel member 47 has a threaded bore engaging the external threads of the lead screw 40.

The counterbalance mechanism 15 for the vehicle 10 includes the extensible extension member 35 and is connected by the pivot connection mount 36 (e.g. ball joint), located at a lower end of the housing 41, which can be pivotally mounted to a portion of the vehicle body 11 adjacent to an interior cargo area in the vehicle 10. The second pivot connection mount 38 (e.g. ball joint) is attached to the distal end of extensible extension member 35 and is pivotally mounted to the closure panel 14 of the vehicle 10.

It is recognized that the resilient element 42, optional, can be used to assist in extension of the counterbalance mechanism 15, as desired. Referring to FIG. 1, shown is the counterbalance mechanism 15 in an expanded state (e.g. the closure panel 14 is open).

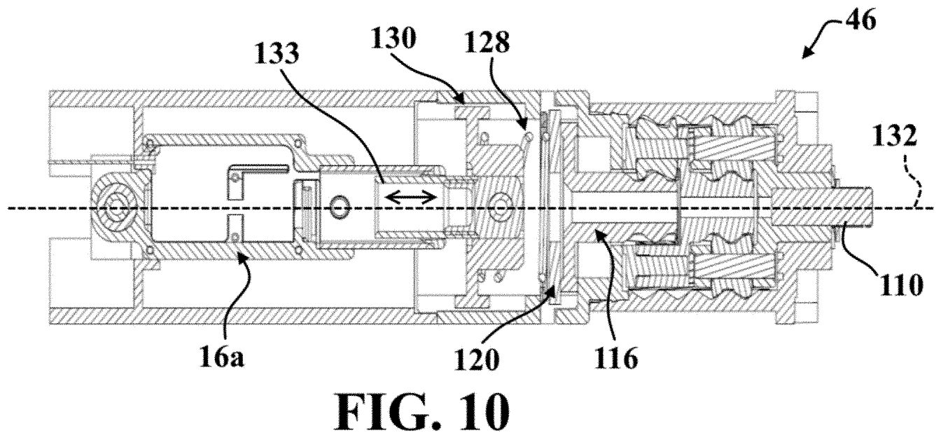

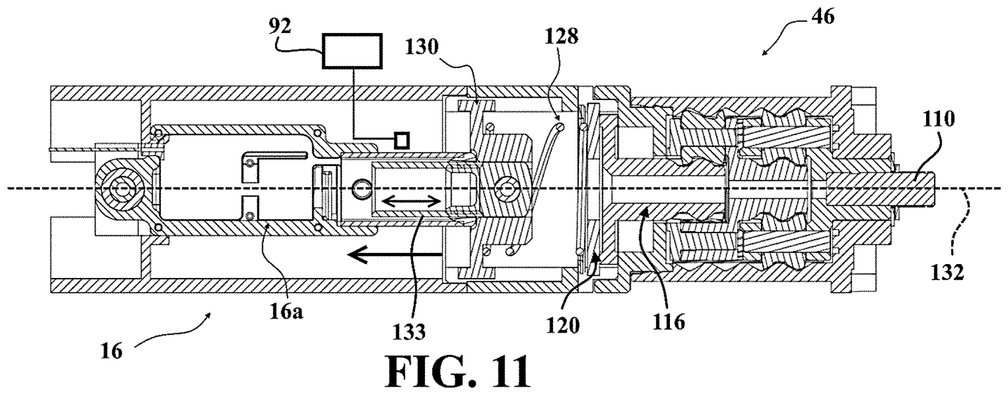

Referring to FIG. 11, shown is the variable friction mechanism 46 at minimum friction being supplied between the friction body 117 of the pinion 116 and the washer 120, as the pusher body 130 is positioned farthest away from the washer 120 along the axis 132, as controlled by operation of the actuator 16a, thus placing the spring 128 in a fully extended state. Since the spring 128 is in the extended state, the force of the spring 128 driving the washer 120 against the friction body 117 is also at a minimum. FIG. 9 is compared to FIG. 11, wherein the variable friction mechanism 46 is shown at maximum friction being supplied between the friction body 117 of the pinion 116 and the washer 120, as the pusher body 130 is positioned closest to the washer 120 along the axis 132, thus placing the spring 128 in a contracted state (as compared to the expanded state shown in FIG. 11). Since the spring 128 is in the contracted state, the force of the spring 128 driving the washer 120 against the friction body 117 is at a maximum. In other words, the closer the pusher body 130 is positioned along the axis 132 with respect to the washer 120, the greater the friction force is generated between the washer 120 and the friction body 117. Similarly, the farther the pusher body 130 is positioned along the axis 132 with respect to the washer 120, the lower the friction force is generated between the washer 120 and the friction body 117. Referring to FIG. 10, shown is an intermediate position of the pusher body 130 along the axis 132, such that the magnitude of friction generated between the friction body 117 and the washer 120 is between the maximum and minimum friction states of FIGS. 11 and 9 respectively.

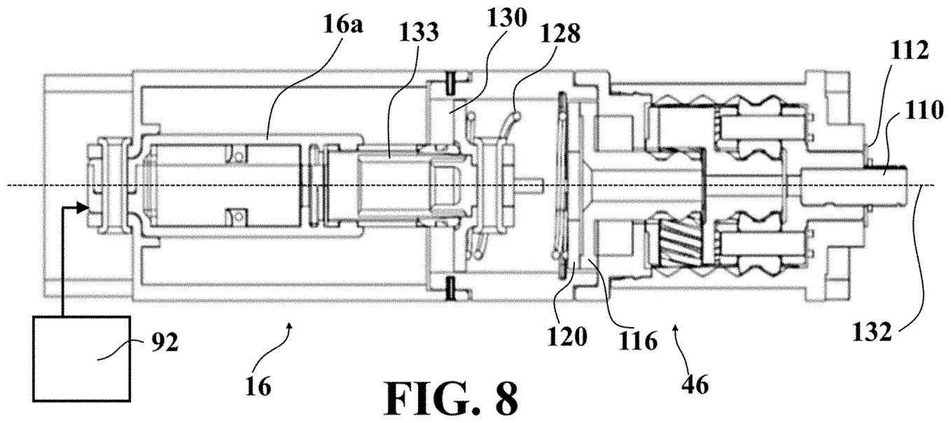

Referring to FIG. 8, shown is the variable friction mechanism 46 with the drive system 16 for coupling to the counterbalance mechanism 15 (see FIG. 3) via the shaft 110.

Referring to FIGS. 3, 4, 5, 6, operation of the counterbalance mechanism 15 is assisted by the variable friction mechanism 46, which changes (i.e. varies) the amount of friction generated by the friction body 117 with washer 120. The rotation of the lead screw 40 about the axis 132 causes relative rotational displacement between the pinion 116 and the washer 120, thus generating the desired friction for a set position of the pusher body 130 along the axis 132. As discussed above, the set position of the pusher body 130 along the axis 132 is determined by operation of the actuator 16a, i.e. operation of the actuator 16a can vary the position of the pusher body 130 (e.g. either closer or further away from the washer 120).

In example operation of closing of the closure panel 14 (e.g. from fully open to fully closed), the operator closes the closure panel 14 by pushing on the closure panel towards the closed position (e.g. see FIG. 1). As the counterbalance mechanism 15 is compressed, the travel member 47 is pushed along the axis 132 by the nut tube 35 (the optional resilient element 42 of the counterbalance mechanism 15 is compressed). As the travel member 47 moves (e.g. translates) towards the pivot mount 36, the lead screw 40 is rotated about the axis 132, which in turn rotates the shaft 110 and the attached carrier assembly 100. The rotating carrier assembly 100 turns the gears 104 which rotate in the stationary ring gear 108, which in turn rotates R (see FIGS. 5 and 6) the pinion 116 according the planetary gear ratio established by the gears 104 in cooperation with the gear 118 of the pinion 116.

The pinion 116 rotates R relative to the washers 120, which has a normal force applied by the spring 128 that is compressed between the pusher body 130 and the washer 120. This normal force F (see FIGS. 5 and 6) creates a Friction Torque between the rotating friction body 117 of the pinion 116 and the stationary washer 120 positioned on one side of the friction body 117. As shown, the washer 120 is positioned between the fiction body 117 and the spring 128. It is recognised that the Friction Torque can be multiplied through the planetary Gear Ratio between the pinion 116, the gears 104, and the ring gear 108, which is then multiplied through the lead screw 40 and the travel member 47 to provide a Linear Friction Force (or Stop-&-Hold function) that resists movement of the extension member 35 and therefore resists movement of the closure panel 14.

Further, the pusher body 130 can travel linearly but cannot rotate relative to the stationary cover 140a. When the drive system 16 (e.g. actuator 16a) is operated to push the pusher body 130 in the direction (e.g. towards the pivot mount 36) for less compression of the spring 128. Thus as the closure panel 14 is operated, the friction torque between pinion 116 and washer 120 can be varied independently of the closure panel 14 interaction with the linear screw 40. For example, when the spring 128 is at its least-compressed position, the Friction Torque is therefore at its minimum, and Stop-&-Hold force of the counterbalance mechanism 15 is therefore at its minimum.

In example operation of opening of the closure panel 14 (e.g. from fully closed to fully open), the operator opens the closure panel 14 by pulling on the closure panel towards the open position (see the closure panel 14 in FIG. 1). As the counterbalance mechanism 15 is extended, the travel member 47 is pushed along the axis 132 by the nut tube 35 (the optional spring 42 of the counterbalance mechanism 15 is extended). As the travel member 47 moves (e.g. translates) away from the pivot mount 36, the lead screw 40 is rotated about the axis 132, which in turn rotates the shaft 110 and connected carrier assembly 100. The rotating carrier assembly 100 turns the gears 104 which rotate in the stationary ring gear 108, which in turn rotates R (see FIGS. 5 and 6) the pinion 116 according the planetary gear ratio established by the gears 104 in cooperation with the gear 118 of the pinion 116.

The pinion 116 rotates R relative to the washer 120, which has the normal force F applied by the spring 128 that is compressed between the pusher body 130 and the washer 120. This normal force F (see FIGS. 5 and 6) creates a Friction Torque between the rotating friction body 117 of the pinion 116 and the stationary washer 120 positioned on one side of the friction body 117. As shown, the washer 120 is positioned between the fiction body 117 and the spring 128. It is recognised that the Friction Torque can be multiplied through the planetary Gear Ratio between the pinion 116, the gears 104, and the ring gear 108, which is then multiplied through the lead screw 40 and the travel member 47 to provide a Linear Friction Force (or Stop-&-Hold function) that resists movement of the extension member 35 and therefore resists movement of the closure panel 14.

Further, the pusher body 130 can travel linearly and be controlled to adopt continuously variable and selectable positions, such as by applying the power input to the drive system 16 until a desired position of the plunger 133 is detected by sensor 93, but pusher body 130 cannot rotate relative to the stationary cover 140a. When the drive system 16 (e.g. actuator 16a) is operated when the closure panel 14 is pushed in the open direction, this can moves the pusher body 130 in the direction (e.g. away from the pivot mount 36) for more compression of the spring 128. Thus as the closure panel 14 opens, the friction torque between pinion 116 and washers 120 can be increased linearly, as desired, until the closure panel 14 reaches the closure panel 14 “Open position”. In the position closest to the pivot mount 38 of the pusher body 130, the spring 128 is at its most-compressed position, the Friction Torque is therefore at its maximum, and Stop-&-Hold force of the counterbalance mechanism 15 is therefore at its maximum.

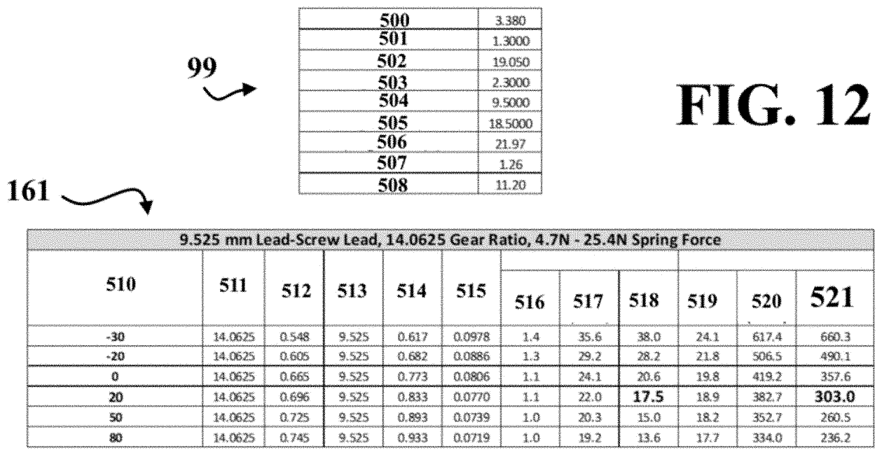

Referring to FIGS. 12,13, shown are self-adjusting friction of the counterbalance mechanism 15 for sample theoretical calculations. Table 99 illustrates values for Spring Total Coils 500, Spring Wire Dia. (mm) 501, Spring free length (mm) 502, Spring Rate (N/mm) 503, Spring L at Max (mm) 504, Spring L at Min (mm) 505, Spring F at Off (N) 506, Spring F at On (N) 507, Radius to Normal Force (mm) 508. Table 161 illustrates values for Temperature (deg C) 510, GB Ratio 511, GB Drive Efficiency 512, LS Lead (mm) 513, LS Drive Efficiency 514, Brake Friction Coef. 515, Minimum friction values of Brake Friction (mNm) 516, Gearbox BD Torq. (mNm) 517, But Tube BD Force (N) 518, and Maximum Friction Values of Brake Friction (mNm) 519, Gearbox BD Tor. (mNm) 520, and Nut Tube BD Force (N) 521.

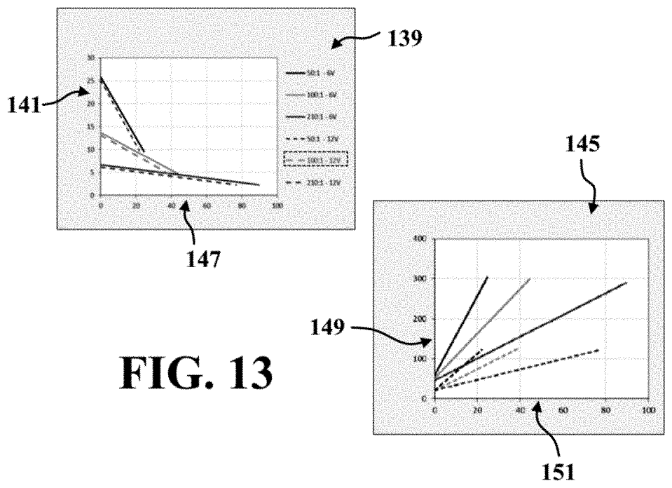

FIG. 13 illustrates an illustrative drive system 16 operating parameters, for instance, Table 139 shows load curves along Speed (mm/s) Y-axis 141 and Force (N) X-axis 147, Table 145 shows current curves along Current (mm/s) Y-axis 149 and Force (N) X-axis 151.

As described above, the friction based counterbalance mechanism 15 is for coupling with the closure panel 14 of the vehicle 10 to assist in opening and closing of the closure panel 14. The counterbalance mechanism 15 can include: the housing 41 having the first pivot mount 36 for connecting to one of the body 11 of the vehicle 10 and the closure panel 14; the extension member 35 (also referred to as the rod 35 by example in FIG. 1) coupled to the housing 41 and being extendable and retractable with respect to the housing 41, the extension member 35 for connecting by the second pivot mount 38 to the other of the body 11 and the closure panel 14; the variable friction mechanism 46 mounted in the housing 41 having the shaft 110 having the axis 132, the washer 120 positioned on the axis 132, the pinion 116 with the friction body 117 positioned on the shaft 110 and adjacent to the washer 120, the pinion 116 rotatable about the axis 132 relative to the washer 120 during rotation of the shaft 110 to generate friction between the washer 120 and the friction body 117, the pusher body 130 positioned variably on the axis 132 in view of operation of the actuator 16a; and the spring 128 positioned on the axis 132 between the pusher body 130 and the washer 120, such that the spring 128 exerts the force F (e.g. axial) on the washer 120 to force the washer 120 against the friction body 117; and the lead screw 40 coupled to the extension member 35 on one end and coupled to the shaft 110 on the other end, such that extension and retraction of the extension member 35 with respect to the housing 41 causes rotation of the lead screw 40 about the axis 132; wherein operation of the actuator 16a changes the axial position of the pusher body 130 on the axis 132 and thus the degree of compression of the spring 128 positioned between the slider body 130 and the washer 120.

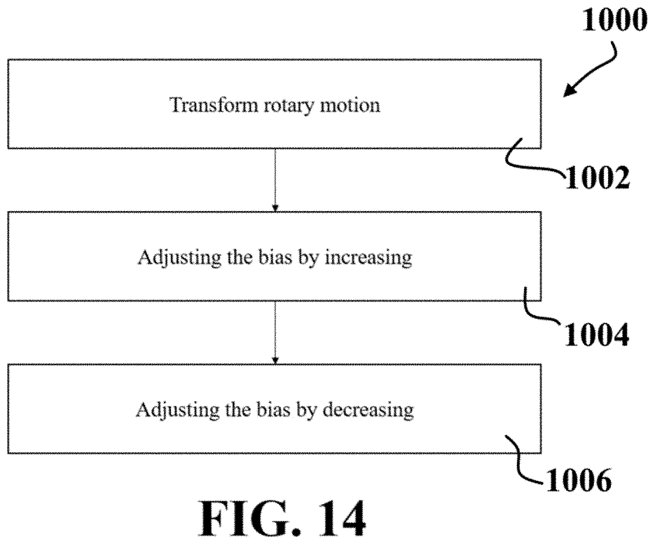

Now referring to FIG. 14, there is illustratively provided a method 1000 of controlling movement of a closure panel 14 of a vehicle 10 between an open position and a closed position with a counterbalance mechanism 15 (e.g. strut), the counterbalance strut having a housing 41 connected to one of the closure panel 14 or the body 11 of the vehicle 10, a lead screw 40 disposed in said housing, a planetary gear set 104,108 disposed in said housing 41 and comprising an output coupled with said lead screw 40 and an input coupled with the friction body 117, a friction member (e.g. washer 120) moveable against the friction body 117, and a telescoping unit operably connected to the other of the closure panel 14 or the body of the vehicle 11, said telescoping unit having an extensible member 35 at least partially received in said housing 41 and having a drive nut (e.g. travel member 47) for converting linear motion of said telescoping unit between a retracted position relative to said housing 41 and an extended position relative to said housing 41 into rotary motion of said lead screw 40.

The method 1000 includes the steps of transforming 1002 the rotary motion of the lead screw 40 into a rotary motion of the pinion 116, adjusting the bias 1004 of (e.g. increasing bias of the friction member 120 towards the friction body 117) the friction member 120 against the friction body 117 of the pinion 116 in response to operation of the actuator 16a to change the axial 132 position of the pusher body 130 in a first direction towards the friction member 120 to increase friction between the friction member 120 and the friction body 117, and adjusting the bias 128 (e.g. decreasing the bias of the friction member 120 towards the friction body 117) the friction member 120 away from the friction body 117 in response to operation of the actuator 16a to change the axial 132 position of the pusher body 130 in second direction opposite the first direction to decrease friction between the friction member 120 and the friction body 117. The step of adjusting the bias 128 (e.g. decreasing the bias of the friction member 120 towards the friction body 117) the friction member 120 away from the friction body 117 in response to operation of the actuator 16a to change the axial 132 position of the pusher body 130 in second direction opposite the first direction to decrease friction between the friction member 120 and the friction body 117 may result in a minimal amount of friction being generated between friction member 120 and the friction body 117 such as less than 50N. The step of adjusting the bias 1004 of (e.g. increasing bias of the friction member 120 towards the friction body 117) the friction member 120 against the friction body 117 of the pinion 116 in response to operation of the actuator 16a to change the axial 132 position of the pusher body 130 in a first direction towards the friction member 120 to increase friction between the friction member 120 and the friction body 117 may result in a maximum amount of friction being generated between friction member 120 and the friction body 117 such as greater than 300N. A continuously variable level of friction being generated between friction member 120 and the friction body 117 may be provided by the position of the plunger 133. If power is removed to the drive system 16, such as a result of a vehicle main power source 199 being disabled or depleted or by command of the controller system 96, the pusher body 130 will remain in its position at such a moment of power loss, or command, and the engagement via the bias 128 to urge friction member 120 against the friction body 117 will be maintained during such a stopped state as a result of the non-backdriveable actuator 16a. In other words, plunger 133 will remain in its position at the moment of power loss and will not be able to be urged to change its position by the bias 128 acting thereon.

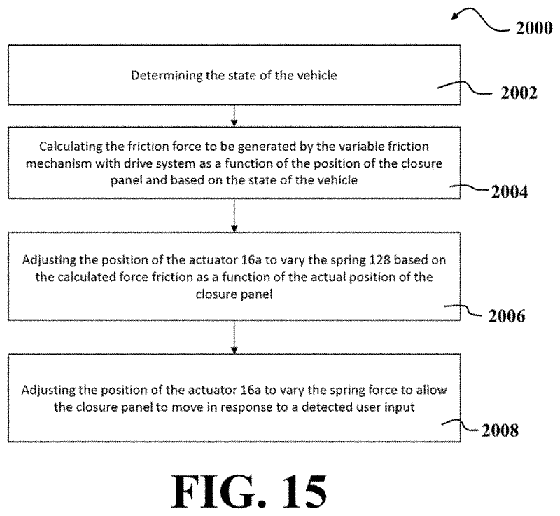

Now referring to FIG. 15 there is illustrated an exemplary method 2000 of controlling movement of a closure panel of a vehicle between an open position and a closed position with the variable friction mechanism 46 and drive system 16 of FIG. 4 using the control system 96 and including the steps of (1) determining 2002 the state of the vehicle, such as determining if the vehicle is on a grade or incline, and the characteristic of the closure panel, such as the gate torque force curve as a function of position, (2) calculating 2004 the friction force using the controller 96 to be generated by the variable friction mechanism with drive system as a function of the position of the closure panel based on the state of the vehicle and the characteristic of the closure panel so as to match the biasing member 37 load countering output force with the closure panel load curve so that the system remains balanced at any point of position of the closure panel, and (3) adjusting 2006 the position of the actuator 16a to vary the bias 128 based on the calculated force friction as a function of the actual position of the closure panel, and (4) adjusting 2008 the position of the actuator 16a to decrease the spring 128 force to allow the closure panel to move in response to a detected user input.

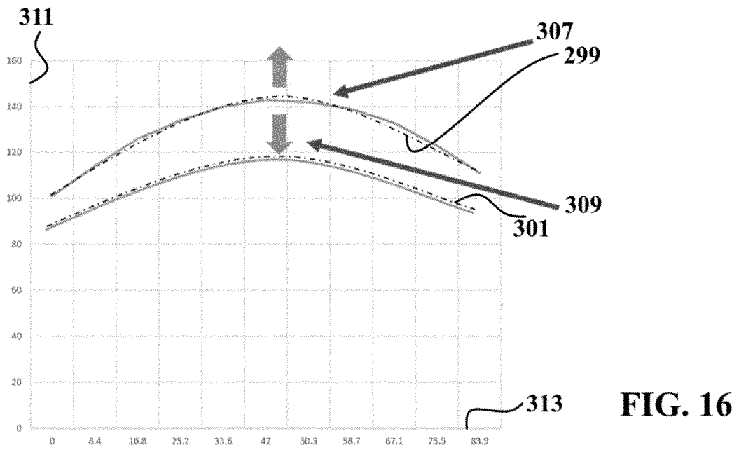

Now referring to FIG. 16, there is illustrated the torque curve (dashed upper line 299) of a closure panel, for example a liftgate, and the torque curve of the biasing member 37 outputting a force countering the load of the liftgate as controlled by the controller 96 varying the variable friction mechanism 46 as a function of the angle (position) of the liftgate as detected by sensor 94. There is illustrated the torque curve 301 (dashed lower line) of a closure panel, for example a liftgate, when the vehicle is on an incline and the torque curve of the biasing member 37 outputting a force countering the load of the liftgate on the incline as controlled by the controller 96 varying the variable friction mechanism 46 as a function of the angle (position) of the liftgate as detected by sensor 94. It is recognized that the state of the vehicle could change the closure panel curve differently. For example, if the sensor senses any addition of an accessory to the vehicle closure panel, such as a tire on a liftgate, the controller 96 will adjust the level of friction generate accordingly to counter the weight of the liftgate with the additional weight of the accessory. Solid lines 303 indicates the torque due to mass of the liftgate, whereas the dashed lines 299, 301 indicate the friction braking force due to the counterbalance. The counterbalance friction braking force can be adjusted by the controller to match the closure panel torque curve, by adjusting the spring, as shown at reference number 307. Change in incline causes gate torque curve to change (e.g. upwards or downwards), controller adjusts the degree of compression of the spring to adjust braking friction force to match the closure panel torque curve when vehicle is on incline as shown by reference numeral 309. The Y-axis 311 in FIG. 16 is titled TORQUE (POSITIVE IS CLOSING) (NM) while the X-axis 313 is titled GATE OPENING ANGLE (ZERO IS CLOSED).

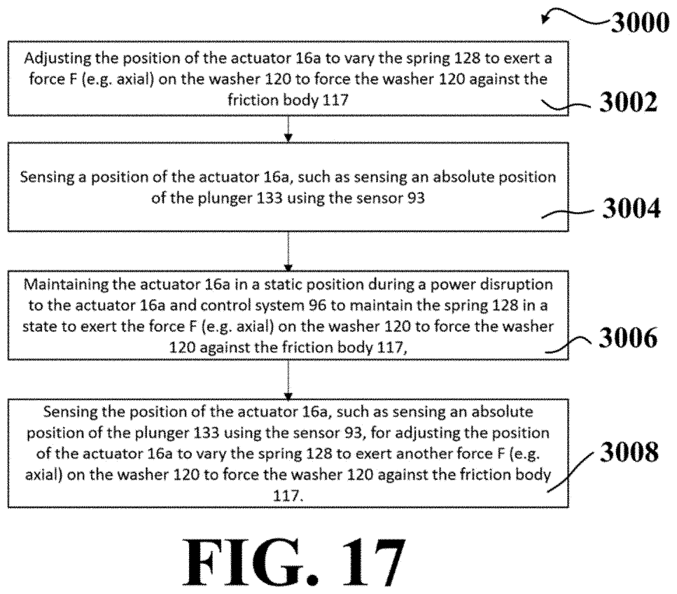

Now referring to FIG. 17 there is illustrated an exemplary method 3000 of controlling movement of a closure panel of a vehicle between an open position and a closed position with the variable friction mechanism 46 and drive system 16 of FIG. 4 using the control system 96 during a power disruption or power source not being available to power the controller 96 and/or actuator 16a and including the steps of adjusting 3002 the position of the actuator 16a to vary the spring 128 to exert a force F (e.g. axial) on the washer 120 to force the washer 120 against the friction body 117, sensing 3004 a position of the actuator 16a, such as sensing an absolute position of the plunger 133 using the sensor 93, maintaining 3006 the actuator 16a in a static position during a power disruption to the actuator 16a and control system 96 to maintain the spring 128 in a state to exert the force F (e.g. axial) on the washer 120 to force the washer 120 against the friction body 117, for example by providing a non-backdrivable actuator, and sensing 3008 the position of the actuator 16a, such as sensing an absolute position of the plunger 133 using the sensor 93, for adjusting the position of the actuator 16a to vary the spring 128 to exert another force F (e.g. axial) on the washer 120 to force the washer 120 against the friction body 117.

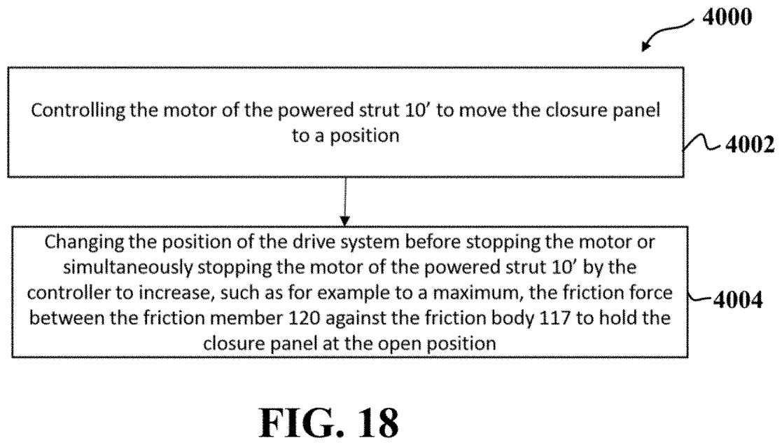

Now referring to FIG. 18 there is illustrated an exemplary method 4000 of controlling movement of a closure panel of a vehicle between an open position and a closed position with the variable friction mechanism 46 and with the drive system 16 of FIG. 4 using the control system 96 and including the steps of (1) controlling 4002 powering the motor of powered strut 10′ to move the closure panel and cutting power to the motor of the powered strut 10′ at a closure panel open position (2) changing 4004 position of the drive system before stopping the motor or simultaneously stopping the motor of the powered strut 10′ by the controller to increase, such as for example to a maximum, the friction force between the friction member 120 against the friction body 117 to hold the closure panel at the open position when the powered strut 10′ has ceased moving the closure panel.

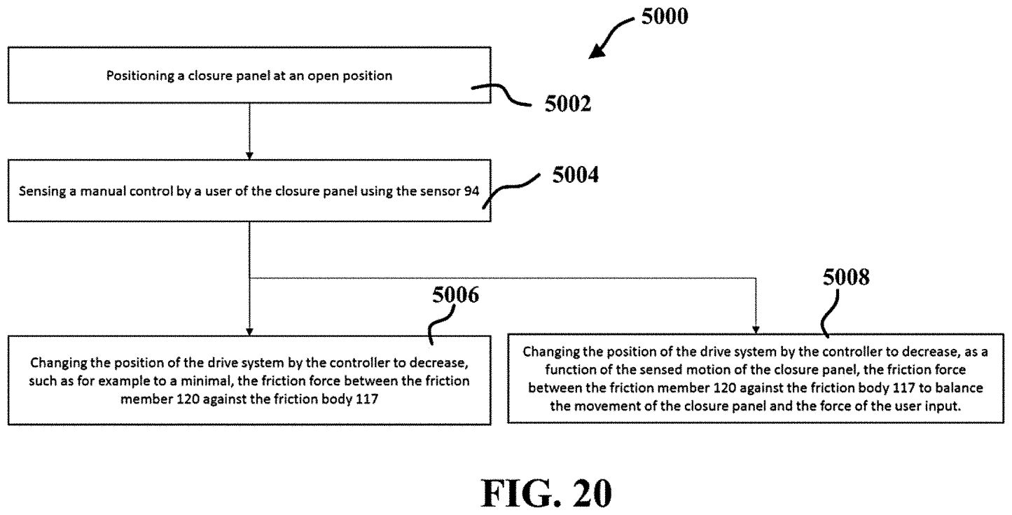

Now referring to FIG. 20, there is illustrated an exemplary method 5000 of controlling movement of a closure panel of a vehicle between an open position and a closed position with the variable friction mechanism 46 and with drive system 16 of FIG. 4 using the control system 96 and including the steps of (1) positioning 5002 a closure panel at an open position (2) sensing 5004 a manual control by a user of the closure panel using the sensor 94 and (3a) changing 5006 the position of the drive system by the controller to decrease, such as for example to a minimal, the friction force between the friction member 120 against the friction body 117 or (3b) changing 5006 the position of the drive system by the controller to decrease, as a function of the sensed motion of the closure panel, the friction force between the friction member 120 against the friction body 117 to balance the output force of the bias 37 with the force of the user input and the closure panel torque to allow the closure panel to move at a controlled rate of speed.

One advantage of the actuator 16a assisted variable friction mechanism 46 is the actuator 16a is activated (e.g. the plunger body 130 moved in position as powered/instructed by the control system 92) to engage or otherwise increase the amount of friction force generated during operation of the counterbalance mechanism 15. In particular, the actuator 16a can be used to actively facilitate (e.g. control) a desired variability in the friction force generated during different stages/positions of the closure panel 14 travel, as the closure panel 14 travels between the open and closed positions.

A further advantage of an actuator 16a assisted variable friction mechanism 46 is the actuator 16a can actively adjust (e.g. the plunger body 130 moved in position as powered/instructed by the control system 92) the friction force generated in order to actively compensate for mechanism wear/degradation (e.g. thinning of components due to material removal due to wear of the components of the variable friction mechanism 46 and/or the counterbalance mechanism 15 during repeated cycling). In particular, the actuator 16a can be used to actively compensate for undesired variability in the friction force generated due to component wear/degradation.

A further advantage of an actuator 16a assisted variable friction mechanism 46 is the actuator 16a can actively adjust (e.g. the plunger body 130 moved in position as powered/instructed by the control system 92) the amount of friction force generated based on a sensed grade (level vs. incline vs. decline) of the vehicle 10 in order to vary (e.g. actively add or remove) a certain amount of friction to facilitate balancing of the closure panel 14 depending on the grade angle of the vehicle 10. For example, the actuator 16a can be used to vary the friction force generated (based on sensed grade angle) in order to inhibit the closure panel 14 from swinging undesirably open/shut on a grade other than level.

A further advantage of an actuator 16a assisted variable friction mechanism 46 is the actuator 16a can actively adjust (e.g. the plunger body 130 moved in position as powered/instructed by the control system 92) the generated friction force based on sensed temperature (e.g. ambient) in order to vary (e.g. add or remove) a certain amount of friction to facilitate the closure panel 14 remains balanced, for example to inhibit the closure panel 14 from swinging undesirably open/shut due to temperature fluctuations. For example, temperature could affect any of the spring/grease/friction pad of the variable friction mechanism 46 and/or the counterbalance mechanism 15, and thus the amount of friction generated, e.g. colder temperatures could make the spring(s) 42, 128 contract and decrease the friction force and/or counterbalance forces generated.

A further advantage of an actuator 16a assisted variable friction mechanism is actuator can actively adjust (e.g. the plunger body 130 moved in position as powered/instructed by the control system 92) the generated friction force as a result of different operating modes of the closure panel 14. For example during a manual mode, there can be a first degree of friction force generated to provide the closure panel 14 is balanced during operation between the closed and open positions. Whereas during a powered mode, the friction is changed by the actuator 16a to a second degree of friction (e.g. less than the first degree of friction) in order to reduce efforts on the motor (e.g. 16a), recognizing that still some friction force generation can remain (e.g. be maintained due to the position of the actuator 16a) in the event vehicle 10 power to the motor of the actuator 16a is lost/interrupted.

A further advantage of an actuator 16a assisted variable friction mechanism is the actuator 16a can actively adjust (e.g. the plunger body 130 moved in position as powered/instructed by the control system 92) the friction force generated based on a user preference setting, or an OEM setting, in order to provide the closure panel 14 with a lighter or heavier feel to the user. For example, during a manual mode the closure panel 14 can be given some resistance to the manual motion (as a result of a selected manual mode position of plunger body 130 by the actuator 16a) based on the user moving the closure panel 14 between the open and closed positions, which would be felt by the user.

A further advantage of an actuator 16a assisted variable friction mechanism 46 is that once the actuator 16a is positioned, if power is lost to the control system 92 of the actuator 16a (e.g. to the motor of the actuator 16a), the actuator 16a can remain/maintain the pusher body 130 in position.

We claim:

1. A variable friction mechanism (46) coupled to a drive system (16) for mounting in a housing (41) of a counterbalance mechanism (15) for a closure panel (14) of a vehicle (10), including:
a shaft (110) having an axis (132);
a friction member (120) positioned on the axis;
a pinion (116) with a friction body (117) positioned on the shaft and adjacent to the friction member, the pinion rotatable about the axis relative to the friction member during rotation of the shaft to generate friction between the friction member and the friction body;
a pusher body (130) positioned on the axis in relation to the friction member; and
an actuator (16a) coupled to the pusher body for varying an axial position of the pusher body along the axis relative to the friction member;
wherein operation of the actuator causes a change in the axial position of the pusher body on the axis and thus a change in a magnitude of the friction generated between the friction member and the friction body.

2. The variable friction mechanism of claim 1 further including a resilient element (128) positioned on the axis between the pusher body and the friction member, such that the resilient element exerts an axial force (F) on the friction member to bias the friction member against the friction body.

3. The variable friction mechanism of claim 1, wherein a degree of compression of the resilient element is dependent upon a degree of compression of the resilient element positioned between the pusher body and the friction member, the degree of compression based on the axial position of the pusher body.

4. The variable friction mechanism of claim 1, wherein the actuator maintains the axial position of the pusher body relative to the friction member once positioned thereto.

5. The variable friction mechanism of claim 1, wherein the friction member is a washer.

6. The variable friction mechanism of claim 1 further including a position sensor (93) provided to detect a linear position of the axial position of the pusher body.

7. The variable friction mechanism of claim 1 further comprising a set of gears (104) coupled to the shaft for conjoint rotation with the shaft and a gear (118) mounted on the pinion, such that the set of gears and the gear are in threaded engagement with one another in order to cause the rotation of the pinion relative to the friction member.

8. The variable friction mechanism of claim 7, wherein the set of gears are mounted in a carrier (102) providing for said set of gears coupled to the shaft.

9. The variable friction mechanism of claim 1, wherein the variable friction mechanism is positioned between the drive system and the counterbalance mechanism.

10. The variable friction mechanism of claim 3 further comprising the set of gears engaged with a ring gear (108) housing the set of gears as a carrier assembly (100).

11. A friction based counterbalance mechanism (15) for coupling with a closure panel (14) of a vehicle (10) to assist in opening and closing of the closure panel, the counterbalance mechanism including:
a housing (41) having a first pivot connection mount (36) for connecting to one of a body (11) of the vehicle and the closure panel;
an extension member (35) coupled to the housing and being extendable and retractable with respect to the housing, the extension member for connecting by a second pivot connection mount (38) to the other of the body and the closure panel;
a variable friction mechanism (46) mounted in the housing having:
a shaft (110) having an axis (132);
a friction member (120) positioned on the axis;
a pinion (116) with a friction body (117) positioned on the shaft and adjacent to the friction member, the pinion rotatable about the axis relative to the friction member during rotation of the shaft to generate friction between the friction member and the friction body;
a drive system (16) including:
a pusher body (130) positioned on the axis in relation to the friction member; and
an actuator (16a) coupled to the pusher body for varying an axial position of the pusher body along the axis relative to the friction member; and
a lead screw (40) coupled to the extension member on one end and coupled to the shaft on the other end, such that extension and retraction of the extension member with respect to the housing causes rotation of the lead screw and the shaft about the axis;
wherein varying the axial position of the pusher body on the axis changes a magnitude of the friction generated between the friction member and the friction body.

12. The friction based counterbalance mechanism of claim 11 further including a resilient element (128) positioned on the axis between the pusher body and the friction member, such that the resilient element exerts an axial force (F) on the friction member to bias the friction member against the friction body.

13. The friction based counterbalance mechanism of claim 12, wherein a degree of compression of the resilient element is dependent upon a degree of compression of the resilient element positioned between the pusher body and the friction member, the degree of compression based on the axial position of the pusher body.

14. The variable friction mechanism of claim 11, wherein the actuator maintains the axial position of the pusher body relative to the friction member once positioned thereto.

15. The friction based counterbalance mechanism of claim 11 further comprising a travel member (47) threadingly engaged with the lead screw, the travel member connected to the extension member, such that said extension and retraction of the extension member with respect to the housing causes translation of the travel member along the axis.

16. The friction based counterbalance mechanism of claim 11 further comprising a second resilient element (42) positioned in the housing between the shaft and the second pivot connection mount.

17. The friction based counterbalance mechanism of claim 11 further comprising a set of gears coupled to the shaft for conjoint rotation with the shaft and a gear mounted on the pinion, such that the set of gears and the gear are in threaded engagement with one another in order to cause the rotation of the pinion relative to the friction member.

18. The friction based counterbalance mechanism of claim 17 further comprising the set of gears engaged with a ring gear housing the set of gears as a carrier assembly.

19. The friction based counterbalance mechanism of claim 11 further comprising a housing (140b) of the variable friction mechanism, the housing having anti-rotation slots for mating with anti-rotation ribs of the friction member in order to inhibit rotation of the friction member about the axis.

20. A method controlling movement of a closure panel of a vehicle between an open position and a closed position using a variable friction mechanism positioned in a counterbalance mechanism, the variable friction mechanism including a friction member positioned adjacent to a friction body of a pinion and a drive system for operating the variable friction mechanism, the method including the steps of:
coupling rotary motion of a lead screw of the counterbalance mechanism with rotary motion of the pinion;
adjusting a bias of the friction member against the friction body by operation of the drive system in a first direction to increase friction between the friction member and the friction body; and
adjusting the bias of the friction member against the friction body by operation of the drive system in second direction opposite the first direction to decrease friction between the friction member and the friction body.
